(19) United States
(12) Patent Application Publication
(10) Pub. No.: US 2024/0359201 A1
(43) Pub. Date: Oct. 31, 2024

(54) DISPENSER DEVICE, CENTRIFUGE COMPRISING SUCH A DISPENSER DEVICE, AND METHOD FOR CLEANING DISPENSER NOZZLES

(71) Applicant: BlueCatBio GMBH, Neudrossenfeld (DE)

(72) Inventors: Wolfgang Mann, Neudrossenfeld (DE); Frank Feist, Concord, MA (US)

(21) Appl. No.: 18/683,887

(22) PCT Filed: Aug. 15, 2022
(86) PCT No.: PCT/EP2022/072745

§ 371 Date: Feb. 15, 2024

(30) Foreign Application Priority Data
Aug. 16, 2021 (DE) 10 2021 121 265.0

(51) Int. Cl. B05B 15/55; B05B 9/04

(52) U.S. Cl. CPC B05B 15/55; B05B 9/0416

(57) ABSTRACT

The invention relates to a dispensing device with a linear drive for the relative movement of a reaction vessel unit along a dispensing unit with at least two dispensing heads, each of which has at least one dispensing nozzle, so that a reaction vessel unit can be arranged under the dispensing nozzles of the dispensing unit in order to fill at least one reaction vessel of the reaction vessel unit, pumps which are each connected by a liquid line to one of the dispensing heads in order to convey a liquid reagent to the respective dispensing head. The invention is characterised in that a pump valve with a first and a second inlet and an outlet is arranged upstream of each of the two pumps, wherein the outlet can be connected to the respective pump, the first inlet can be connected to a common reagent stock and the second inlet can be connected to an individual reagent stock.

The invention relates to a dispensing device, a centrifuge with such a dispensing device and a method for cleaning dispensing nozzles.

WO2018/234420 A1 discloses a centrifuge for cleaning reaction vessel units. This centrifuge has a rotor and a rotor chamber in which the rotor is rotatably mounted. A reaction vessel unit is inserted into the centrifuge with its openings facing outwards, so that the reagents contained therein are expelled from the respective reaction vessels when the rotor rotates. This allows the reaction vessels to be cleaned essentially residue-free.

This known centrifuge is provided with a loading and unloading device, which has a linear drive to move reaction vessel units to be centrifuged into the rotor chamber and to remove them from the rotor after centrifugation. In this loading and unloading device, the reaction vessel unit is pulled into the rotor or pushed out of the rotor by means of a sliding rod. Such a loading and unloading device allows the centrifuge to be integrated into an automatic system in which the centrifuge is one of several workstations and the reaction vessel units are automatically transferred from one workstation to another without the need for manual intervention.

The centrifuge also has a dispensing device which has several dispensing nozzles. The dispensing nozzles are arranged above the path travelled by a reaction vessel unit during loading or unloading by means of the loading and unloading device and point downwards with their openings, so that the reaction vessels of the reaction vessel unit can be arranged below the dispensing nozzles by means of the loading and unloading device, so that liquid reagents can be introduced from the nozzles into the respective reaction vessels in a targeted manner.

WO2017/125598 A1 shows another centrifuge, which in turn has a loading and unloading device in which reaction vessel units are positioned by means of a rigid sliding rod.

A centrifuge with a dispensing device is known from US 2002/0090729 A1. Furthermore, a computer control is provided to feed liquid solvents to several dispensing stations within a centrifuge chamber.

EP 2 269 723 A2 describes a device for chemical synthesis and in particular for synthesising nucleic acids in a large number of reaction vessels. The device has dispensing heads, each with a cluster of nozzles, which are connected to a plurality of reagent sources. In this way, different reagents can be dispensed with a single dispensing head.

DE 694 33 635 T2 describes a device and a process for synthesising polymers, in particular oligonucleotides, for use on arrays. A dispensing device with several nozzles is also used here.

US 2020/0009623 A1 describes a device for cleaning nozzles, wherein the nozzles can be immersed in a cleaning solution which is held in a cleaning tank. Furthermore, the nozzles are cleaned using ultrasonic waves.

DE 10 2012 015 083 B3 specifies a dispensing head with several movable dispensers. This dispensing head is intended to dispense liquid samples into a microtiter plate, wherein the dispensing head has several dispensers. The individual dispensers, which are also referred to as microdispensers, can be moved out of the dispensing head individually for a dispensing process.

The invention is based on the task of creating a dispensing device and a centrifuge with such a dispensing device, with which small quantities of liquid reagent can be repeatedly, automatically and reliably added to reaction vessels, wherein the waste of reagent is to be kept to a minimum.

A further task of the present invention is to provide a method for cleaning dispensing nozzles, wherein the cleaning of the dispensing nozzles can be fully automatic and the dispensing nozzles can be used for dispensing a reagent.

One or more of the tasks are each solved by one of the objects of the independent claims. Advantageous embodiments are indicated in the respective subclaims.

According to a first aspect of the invention, a dispensing device is provided with
a linear drive for relatively moving a reaction vessel unit along a dispensing unit with at least two dispensing heads, each having at least one dispensing nozzle, so that a reaction vessel unit can be arranged under the dispensing nozzles of the dispensing unit in order to fill at least one reaction vessel of the reaction vessel unit, and
pumps, each of which is connected to one of the dispensing heads by a liquid line, for conveying a liquid reagent to the respective dispensing head.

The dispensing device is characterised in that a pump valve with a first and a second inlet and an outlet is arranged upstream of the two pumps, wherein the outlet can be connected to the respective pump, the first inlet to a common reagent stock and the second inlet in each case to an individual reagent stock.

By providing one of the pump valves upstream of each of the pumps, it is possible to connect an individual reagent stock to the two inlets of the pump valves, which contains a reagent that is only supplied to this pump and the dispensing head connected to it, and to connect a common reagent stock that is connected to several, in particular all, pump valves, so that the reagent held in the common reagent stock can be supplied to several pumps and thus several dispensing heads. Connecting the common reagent stock to several pump valves causes relatively long delivery routes, as the lines to the individual pumps have to branch out. Long delivery paths mean a large dead volume, especially if the reagents supplied to the first inlet of the pump valves are to be exchanged. For this reason, the common reagent stock is primarily intended for inexpensive reagents that are often used in large quantities, such as washing solutions, cleaning solutions, buffer solutions, etc. The individual reagent stock is only connected to a single pump valve, so that the reagent it contains is only supplied to a single pump and therefore a single dispensing head. This has the advantage that no complex valve circuits are required between the reagent supply and the pump valve. The dead volume of the individual reagent contained in the individual reagent stock is limited to the area of the pump valve up to the dispensing nozzle of the respective dispensing head. This dead volume can be kept small. As a result, the losses of such an individual reagent are low when other reagents, in particular common reagents, are delivered via the pump or the corresponding dispensing nozzle. Therefore, the individual reagent stock can be used to hold very expensive reagents and dispense them into the reaction vessels of the reaction vessel unit as required, as the losses are low when other reagents, such as washing solutions, cleaning solutions, buffer solutions, etc., are dispensed to the reaction vessels via the same dispensing head.

Another advantage of providing individual reagent stocks is that frequently required reagents are kept in the individual reagent stocks, which can be dispensed again and again without the need to replace the reagent in the respective dead volume. Other reagents can be added from the common reagent stock via one of the other dispensing heads. For example, it is possible to repeatedly dispense a particular assay with several different reagents without having to exchange or rinse the individual dead volumes of the individual reagent stocks. On the one hand, this avoids losses of the individual reagents and, on the other hand, saves considerable time, as the dead volumes of the individual reagent stocks do not need to be rinsed. The dead volume of the individual reagent stocks only needs to be rinsed if all liquid paths are rinsed with cleaning solution and disinfected as part of an internal cleaning process.

Because both an individual reagent and one or more common reagents can be dispensed via a dispensing head, the dispensing head and the dispensing nozzles arranged on it can be rinsed with a cleaning solution. Rinsing with a cleaning solution can be carried out fully automatically, wherein the corresponding valves and the corresponding pump are controlled fully automatically by means of a central control device. This allows long-lasting operation of the dispensing device without the need for manual intervention, as the dispensing nozzles can be kept clean even during long periods of operation. In particular, the dispensing nozzles can be kept sterile and incrustation due to drying out of a saline buffer solution can be prevented. With conventional dispensing devices for dispensing reagents, it is usually necessary to clean the dispensing nozzles or the dispensing head manually from time to time. This is time-consuming and significantly impairs the throughput of an automatic system for handling and processing reaction vessel units. In integrated plants and systems, the dispensing nozzles are often difficult to access. Automatic cleaning can significantly simplify the operation of the dispensing device. The present dispensing device can be easily integrated into such an automatic system, as the essential functions for continuous operation are carried out by the dispensing device itself. Only the reagent supplies need to be replenished from time to time.

A dispensing head usually consists of a one-piece body and has one or more dispensing nozzles. The nozzles can be arranged vertically downwards (angle=0° relative to the vertical) or at an angle of preferably 2°, 5°, 20° or 30° relative to the vertical (no more than 90°). The nozzles can also be arranged in a variable or swivelling manner with respect to the vertical. Within the scope of the invention, such a dispensing head can also be of multi-part design, wherein a dispensing head is connected to a single pump for conveying the reagents to the dispensing head. If such a dispensing head has a multi-part design, then the fluid connection within the individual parts of the dispensing head can be formed internally or also by a branching of the fluid line from the pump to the respective parts of the dispensing head.

Preferably, a distributor arrangement with one inlet and several outlets is arranged between the common reagent stock and the pump valves, wherein each second inlet of the respective pump valve is connected to an outlet of the distributor arrangement. The distributor arrangement is designed so that the individual outlets of the distributor arrangement can be switched individually. The distributor arrangement can be used to supply the reagent from a common reagent stock specifically to different pumps or specifically to the respective dispensing heads.

Furthermore, the common reagent stock can have a valve arrangement with several inlets and one outlet, wherein the outlet of the valve arrangement is connected to one or more of the first inlets of the pump valves and a reagent storage container can be coupled to each of the inlets of the valve arrangement. This valve arrangement enables several different reagent storage containers to be provided in the common reagent stock in order to provide different reagents for delivery to the dispensing heads. This valve arrangement can be connected directly to the first inlets of the pump valves or indirectly to the first inlets of the pump valves via one or more of the distributor arrangements explained above.

The second inlets of the pump valves are preferably each designed to be coupled directly to a reagent storage container. This means that no additional elements, such as valves or the like, are provided between the second inlets of the pump valves and the outlet of the reagent storage container. The outlets of the reagent storage containers and the second inlets of the pump valves are merely connected to each other by a liquid line, such as a hose, and corresponding coupling elements.

A shut off valve can be arranged between the pumps and the respective dispensing head. Such a shut off valve is used to stop the flow of liquid to the respective pump head abruptly. As a result, the amount of liquid reagent dispensed with the dispensing nozzles of the respective dispensing head can be precisely dosed.

Preferably, the liquid lines between the pumps and the respective dispensing heads have a smaller cross-section than the liquid lines leading from the pumps to the reagent storage containers. Since both the individual reagent and the common reagents are to be conveyed through the liquid lines between the pumps and the respective dispensing heads, these liquid lines represent a dead volume when changing the reagents, which must be emptied when changing the reagents and causes corresponding losses. These losses should be kept as low as possible, which is why it is advisable to keep the cross-section of these liquid lines small.

The dispensing heads can each have several nozzles.

The dispensing heads can be detachably coupled to each other.

The dispensing heads can be arranged interchangeably on the dispensing device.

The dispensing heads can be connected to the dispensing device or to each other by means of a magnetic coupling, to the dispensing device or to each other by means of a screwable connection and/or by means of a detachable snap-in connection. The dispensing heads preferably have a detachable hose connection so that they can be detachably coupled to a liquid line leading to the respective dispensing head.

The dispensing heads may each have a plurality of nozzles arranged in series, wherein each dispensing head has one or more rows of nozzles and the row of nozzles each comprises the same number of nozzles or a different number of nozzles. Each dispensing head can have a single row of dispensing nozzles or several rows of dispensing nozzles. The individual rows of dispensing nozzles can always have the same number of nozzles per row. However, it is also possible for the number of nozzles per row to differ. Such rows with a different number of nozzles can be provided within a dispensing head or several dispensing heads can also be connected to one another, each with a single row of nozzles, wherein the individual dispensing heads can have rows with a different number of nozzles. If an arrangement with rows with different numbers of nozzles is provided, then the arrangement can be designed in such a way that a regular grid of nozzles is formed and/or the rows alternately have a certain number of nozzles. Such a regular grid of nozzles is in particular a rectangular grid, especially a square grid, i.e. four neighbouring nozzles are arranged at the corners of a square. This arrangement of the nozzles corresponds to the positions of the reaction vessels on the respective reaction vessel unit, which is in particular a microtiter plate. The rectangles or squares can be arranged with their edges parallel to the edges of the respective reaction vessel unit, which is in particular a microtiter plate. These rectangles or squares can also be arranged in a diamond shape with respect to the reaction vessel unit, i.e. the edges of the rectangles or squares each enclose an angle of 45° to the outer edges of the reaction vessel unit.

The design of a dispensing device with a different number of nozzles per row represents an independent inventive concept, which can also be used independently of the first aspect of the dispensing device explained above.

The dispensing heads can preferably be coupled together in a form-fit manner. This ensures that the individual dispensing heads are positioned exactly in relation to each other.

The dispensing device can also have a temperature control device for controlling the temperature of a reagent to be supplied to the dispensing head. This temperature control device can be formed along the liquid line between the pumps and the respective dispensing heads. The temperature control device can, for example, be made of a thermally conductive tube that is surrounded by a heating or cooling device, such as a Peltier element. The tube can be made of copper, for example. It may be useful to coat the inner surface of the tube with an inert material or to additionally provide a thin-walled plastic tube inside the tube. Furthermore, the pump valve and/or the respective pump itself can be temperature-controlled. Due to their comparatively large masses, these parts have a high heat capacity so that the temperature can be kept very stable and the flow of reagents does not lead to any significant temperature change.

Preferably, the liquid line leading from the pump valve of one of the individual reagent stocks to the respective dispensing head is no longer than 50 cm, in particular no longer than 40 cm and preferably no longer than 30 cm or no longer than 20 cm. This length has a significant influence on the dead volume of the individual reagent stocks.

The dispensing device can have a collection basin in the area below the dispensing heads for collecting liquid reagents dispensed with the dispensing nozzles. This collection basin is used to allow reagents that are conveyed through the dispensing nozzles and are not to be fed to a reaction vessel to be discharged in a controlled manner. These are, for example, cleaning solutions that are used to wash the dispensing nozzles. These are also the dead volumes to be removed when changing reagents.

According to a further aspect of the invention, a centrifuge is provided which has a rotor and a rotor chamber in which the rotor is arranged and rotatably mounted, wherein the rotor has a reception area for receiving the reaction vessel unit, and the rotor chamber is bounded by a housing. This centrifuge is characterised by a dispensing device as explained above.

The rotation axis of the rotor is preferably arranged parallel to a standing surface of the dispensing device. As a result, the rotation axis of the rotor is arranged horizontally during operation. Such an arrangement of the rotation axis allows easy loading of the centrifuge with a reaction vessel unit, as this can be introduced into the rotor chamber with the openings of the reaction vessels pointing upwards. In reaction vessel units with large-volume reaction vessels (e.g. microtiter plate with 96 reaction vessels), the liquid does not necessarily adhere completely due to capillary forces in reaction vessels. If the rotation axis is arranged horizontally, such reaction vessel units can be turned once after insertion into the rotor chamber or rotor by turning the rotor through 180° so that their openings point downwards. A large part of the liquid then flows out of the reaction vessel units and drips directly downwards. The remaining liquids in the reaction vessels, which adhere due to surface tension, can then be centrifuged out

According to a further aspect of the present invention, a method for cleaning dispensing nozzles is provided, in which the dispensing nozzles are arranged on at least two different dispensing heads and reagents are metered to each dispensing head with a respective pump and using a pump valve arranged upstream of the pump and having a first inlet, a second inlet and an outlet, wherein the outlet is connected to the pump, the first inlet is connected to a common stock of cleaning solution and the second inlet is connected to an individual reagent stock containing the respective reagent, so that the cleaning solution itself is supplied to the respective dispensing heads by the pump valves as required for rinsing the dispensing nozzles.

If a certain reagent is repeatedly fed through dispensing nozzles, there is a risk of the nozzles becoming contaminated. If the reagent contains salts, for example, the salts can remain at the nozzle openings when the liquids evaporate from the nozzles and clog them over time. Other components of the reagents can also lead to contamination and clogging of the nozzles. This is particularly true if the reagent is repeatedly left in the lines and dispensing nozzles for long periods of time. To avoid such contamination, the dispensing heads and the corresponding dispensing nozzles can be rinsed with a cleaning solution from time to time. A common reagent stock of cleaning solution can be provided for several dispensing heads, wherein an individual reagent stock is provided for each dispensing head or pump. The individual reagent stock, i.e. the reagent stock predetermined for the respective pump or for the respective dispensing head, provides a reagent that can also be very expensive. Due to the individual allocation of the individual reagent stock to the respective dispensing head, there is only a small dead volume, which is why losses are low when the dispensing head is rinsed with the cleaning solution. The cleaning solution usually compares favourably with the individual reagents. The common supply of cleaning solution can therefore be fed to the different pumps via a branched pipe system. This makes it possible to clean the dispensing nozzles regularly and still keep losses of the individual reagent to a minimum.

Another aspect of the invention relates to a cleaning adapter for a dispensing head. The dispensing head has one or more dispensing nozzles for dispensing a liquid reagent via the outer surface of the at least one nozzle. The cleaning adapter has a trough-shaped adapter body with a bottom wall, two longitudinal side walls and two end walls, which define an upward-facing opening. The upward-facing opening is adapted to the contour of the dispensing head in such a way that the cleaning adapter can be attached to the dispensing head in the area where the dispensing nozzles protrude in such a way that the cleaning adapter is essentially fluid-tight against the dispensing head. A continuous cleaning opening is formed in the bottom wall of the adapter body for each dispensing nozzle of the dispensing head, so that when the cleaning adapter is attached to the dispensing head, one of the dispensing nozzles extends through one of the through openings in each case. The dispensing nozzles are each arranged with some play in the cleaning openings. The cleaning adapter has at least one connection opening with a connection element for connecting a line for supplying or discharging a cleaning fluid.

It has been shown that dispensing nozzles become contaminated, particularly in the area of their exposed tips, and both clog the nozzle openings and adhere to the circumference of the tips of the dispensing nozzles. In addition, droplets can adhere to the dispensing nozzles, which only come off during the next dispensing process and can possibly lead to a shift in the desired concentration or even contaminate the sample. There is therefore a considerable need to continuously clean such dispensing nozzles.

The cleaning adapter makes it possible to clean the dispensing nozzles during operation of a dispensing device. Due to the fact that the dispensing nozzles are arranged with clearance in the cleaning openings of the cleaning adapter, a cleaning channel is formed between the respective dispensing nozzles and the inner surface of the cleaning openings of the cleaning adapter, through which, on the one hand, a cleaning agent for cleaning the dispensing nozzles can be conveyed along the dispensing nozzles to the exposed ends or tips of the dispensing nozzles in order to remove deposits on the outer circumference of the dispensing nozzles. It is also possible to suck in droplets hanging from the tips of the dispensing nozzles through this cleaning channel and pick them up in the cleaning adapter and pass them on from there.

The cleaning adapter is preferably shaped in such a way that the dispensing nozzles only protrude a small distance from the cleaning adapter. This protrusion is preferably not larger than 4 mm or not larger than 3 mm and in particular not larger than 2 mm. With such a small protrusion, droplets can be reliably aspirated at the pipetting nozzles and drawn in by the cleaning adapter.

The clearance width of the cleaning openings is preferably at least 0.1 mm, in particular at least 0.2 mm, larger than the outer diameter of the dispensing nozzles. The greater the clearance between the dispensing nozzle and the respective cleaning opening, the easier it is to pass cleaning agent through this cleaning channel. It is therefore expedient if the clearance width of the cleaning channel is greater than 1.5 times, in particular greater than 2 times and preferably not greater than 2.5 times the outer diameter of the corresponding dispensing nozzles.

However, the clearance width should not be more than 1 mm larger than the outer diameter of the dispensing nozzles and is preferably no more than 0.5 mm larger than the outer diameter of the dispensing nozzles. The smaller the clearance of the dispensing nozzles in the cleaning openings, the greater the flow rate in the cleaning channel. A small clearance therefore means a high flow rate and thus a strong suction effect to suck up drops from the tip of the pipetting nozzles. It is therefore expedient if the clearance width of the cleaning channel is not greater than 2.5 times, in particular not greater than 2 times and preferably not greater than 1.5 times the outer diameter of the corresponding dispensing nozzle.

The cleaning adapter allows continuous operation of a dispensing device without the dispensing nozzles becoming contaminated and/or without unwanted droplets remaining on the free ends or free tips of the dispensing nozzles after the respective dispensing processes. This prevents contamination and changes in the composition of the samples. Continuous cleaning of the dispensing nozzles is possible without stopping the operation of the dispensing device and without having to remove the dispensing nozzles. It is also not necessary to manually intervene in the process to clean the dispensing nozzles. The cleaning process can be carried out automatically and is therefore suitable for integration into the process of a fully automatic dispensing device.

The cleaning adapter can have at least two connection openings, which are preferably arranged diametrically opposite each other on the end walls. A line for supplying cleaning fluid and a line for extracting cleaning fluid or suspended droplets of the liquids to be dispensed can be connected to each of the two connection openings. The line for supplying cleaning fluid can be used to rinse the dispensing nozzles. Drops adhering to the dispensing nozzles can be suctioned off using the line for removing cleaning fluid. However, the cleaning adapter can also be operated in such a way that cleaning fluid is simultaneously supplied and removed in order to rinse the cleaning adapter itself. It is therefore useful if the connection openings on the cleaning adapter are arranged diametrically opposite each other so that the entire cleaning adapter is rinsed.

The cleaning adapter can be provided with an elastic sealing element at the upward-facing opening to seal the cleaning adapter against the dispensing head. However, the sealing element can also be attached to the dispensing head itself. However, a contour of the cleaning adapter precisely adapted to the shape of the dispensing head without an additional sealing element is also sufficient to create an essentially fluid-tight connection between the cleaning adapter and the dispensing head, as fluid contained in the cleaning adapter can escape from it due to the cleaning channels through the cleaning openings, so that the resulting pressure differences between the interior of the cleaning adapter and the environment cannot become very large and thus the connection area between the cleaning adapter and the dispensing head is not subjected to a large pressure. The fluid tightness therefore does not have to withstand high pressures.

Preferably, the cleaning adapter is provided with one or more fixing elements in order to fix the cleaning adapter to the dispensing head and/or to a dispensing device comprising the dispensing head.

According to a further aspect, a dispensing head with one or more dispensing nozzles is provided for dispensing a liquid reagent via the one or more dispensing nozzles, wherein the dispensing head comprises a purification adapter as explained above.

The cleaning adapter can be arranged as an additional component on the dispensing head. However, the cleaning adapter can also be an integral part of the dispensing head.

According to a further aspect, there is provision of a dispensing device comprising a dispensing head having at least one dispensing nozzle for dispensing a liquid reagent via at least one dispensing nozzle, wherein
the dispensing device has a cleaning adapter as described above and/or a dispensing head with cleaning adapter as described above and is provided with a pump which is connected to the cleaning connection by a fluid line in order to supply or remove a cleaning fluid to or from the cleaning adapter.

According to a further aspect, a method for cleaning one or more dispensing nozzles of such a dispensing device is provided, wherein a cleaning fluid is either
fed exclusively to the cleaning adapter so that the dispensing nozzle(s) is/are flushed with the cleaning fluid, or
pulled off exclusively from the cleaning adapter so that droplets on the dispensing nozzles are drawn into the cleaning adapter, or
simultaneously fed to the cleaning adapter via one connection opening and removed via another connection opening so that the cleaning adapter is rinsed.

The method preferably uses a cleaning fluid formed from one or a mixture of the following fluids:
Air
Alcohols, such as ethanol, isopropanol, PEG, etc.
Aqueous solution, in particular with surfactants, soap-like reagents or reagents that are particularly suitable for dissolving salts and other contaminants.
The same cleaning fluid as used to clean the inside.
Acid, e.g. citric acid, acetic acid.
Base, such as caustic soda (NaOH), caustic potash (KOH), sodium hypochlorite.

Suitable mixtures include, for example, caustic soda or potassium hydroxide solution with an alcohol such as ethanol or PEG. Such a mixture can also be based on an acid, such as citric acid, to which an alcohol such as isopropanol or PEG is added.

Acidic or alkaline solutions dissolve (=lyse) cell membranes and thus ensure that no biofilms form.

The applicant sells such cleaning solutions under the trade names BlueDaily® and BlueIntense®.

The invention is explained in more detail below by way of example with reference to the drawings. The drawings show in:

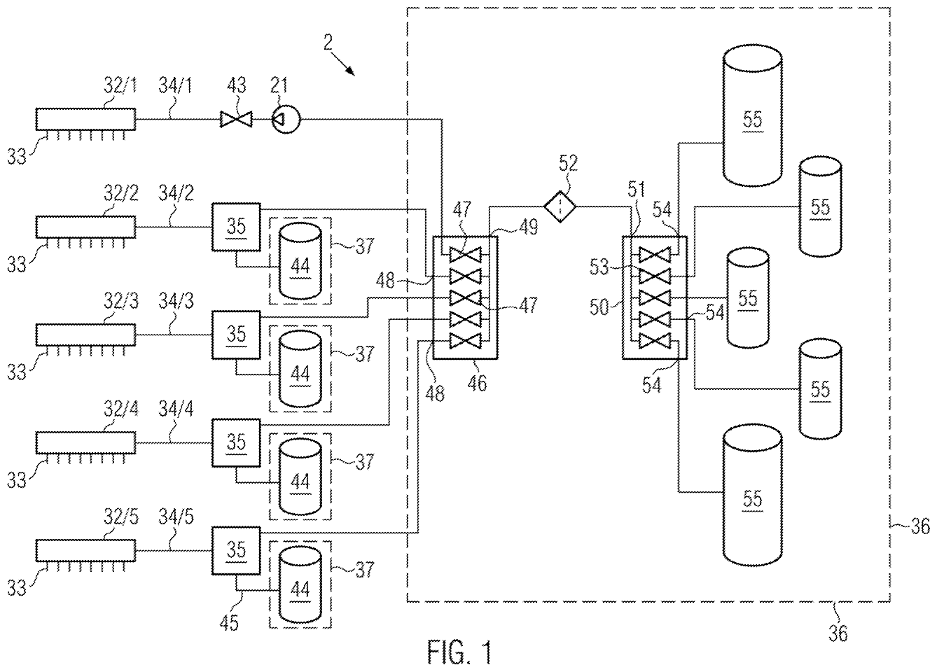

FIG. 1A dispensing device with several dispensing heads schematically in a block diagram,

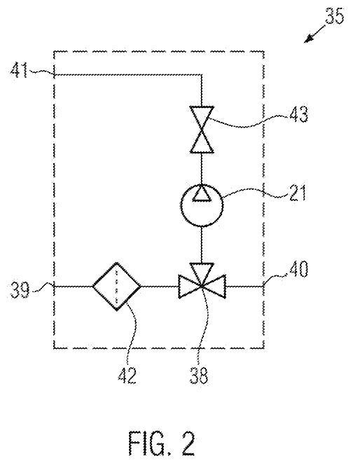

FIG. 2A fluidisation unit for supplying a dispensing head from two different reagent supplies in a schematic fluidisation plan,

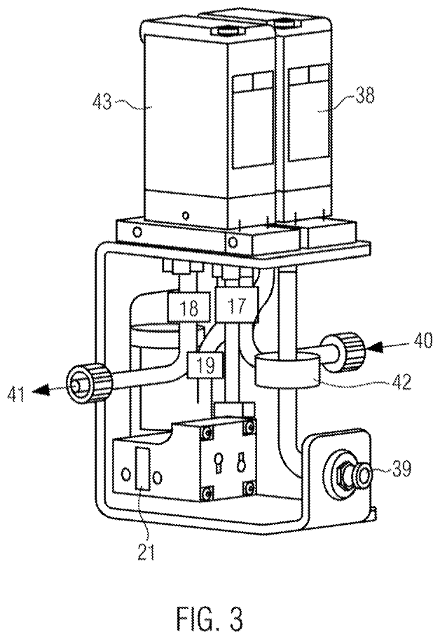

FIG. 3: Perspective view of the fluidisation unit from FIG. 2,

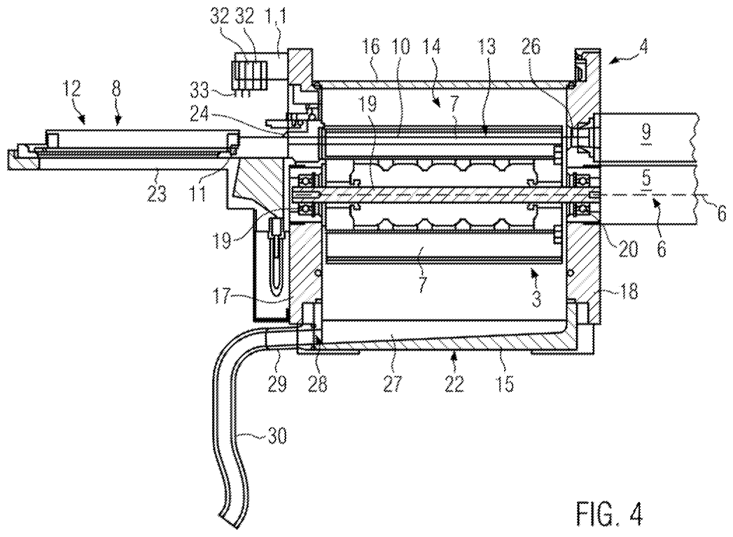

FIG. 4A centrifuge with a dispensing device schematically simplified in a partial section,

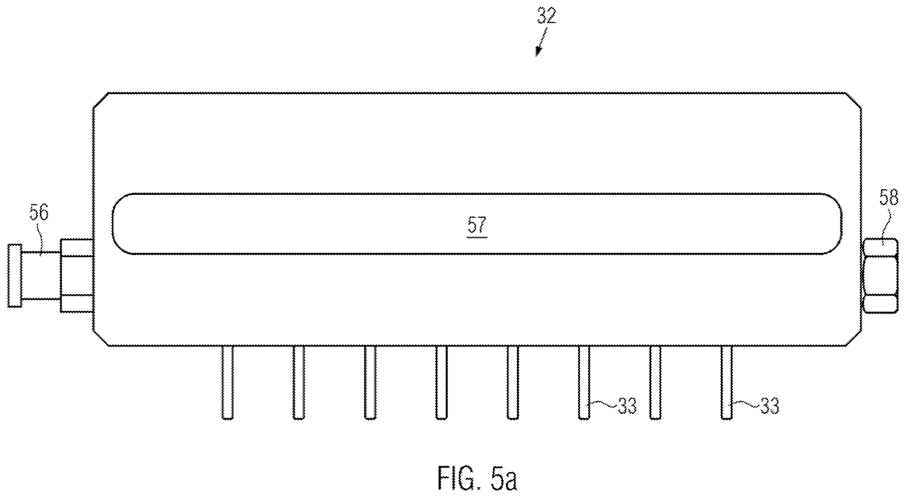

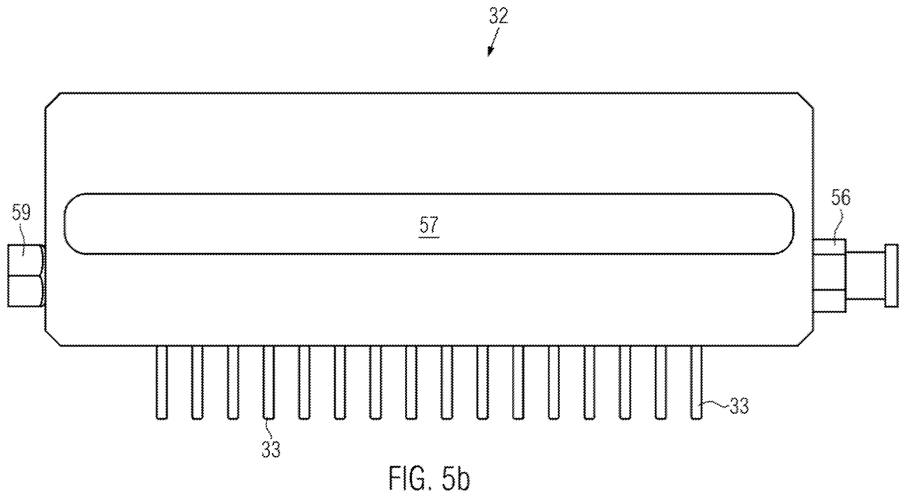

FIGS. 5a, 5b: Perspective view of different dispensing heads

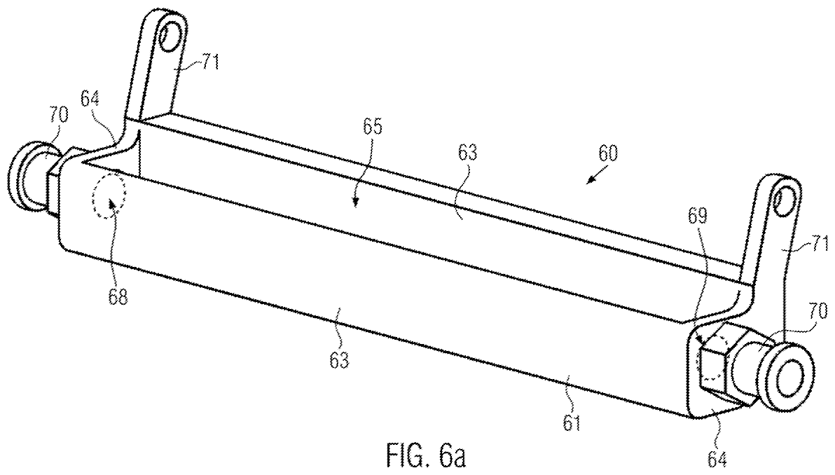

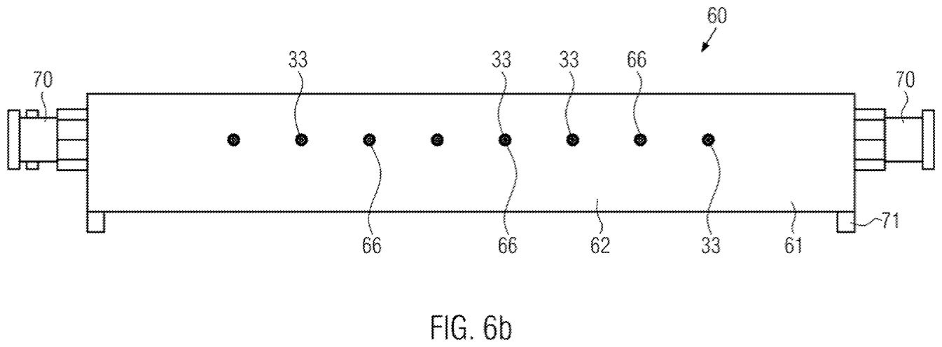

FIGS. 6a, 6b show a perspective view of a cleaning adapter and a view from below,

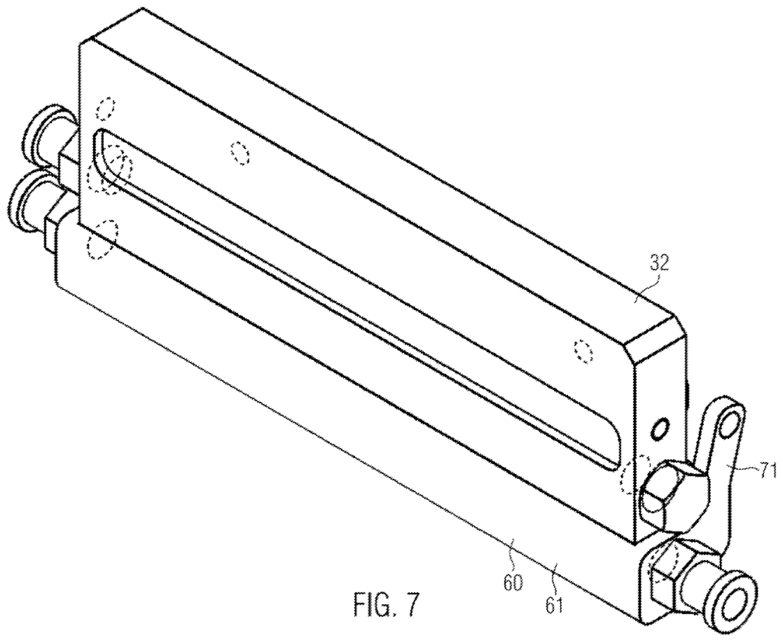

FIG. 7A dispensing head and a cleaning adapter arranged thereon in perspective view, and

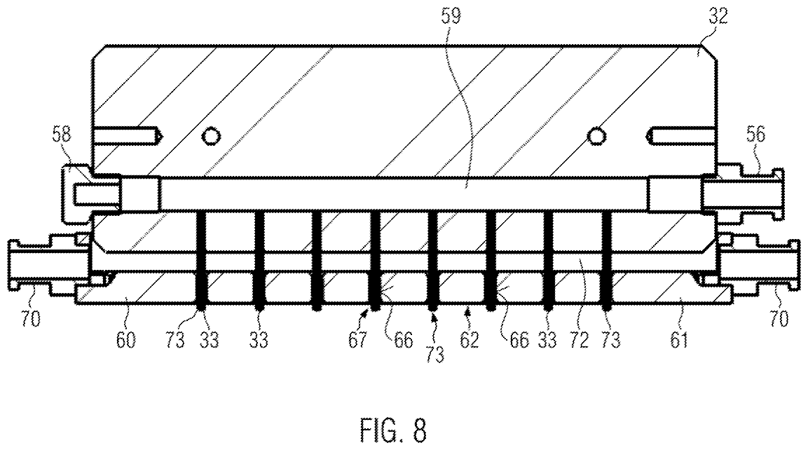

FIG. 8 The dispensing head and the cleaning adapter from FIG. 7 in a sectional view, wherein the sectional plane is spanned by dispensing nozzles located therein.

The invention is explained below with reference to an embodiment example of a centrifuge 1 (FIG. 4) with a dispensing device 2 (FIGS. 1-3). The centrifuge 1 has a rotor 3, a housing 4, a drive unit 5 for rotating the rotor 3 about a rotation axis 6.

The rotor 3 has at least one reception area 7 for receiving a reaction vessel unit 8. The reaction vessel unit 8 is usually a microtiter plate. Such microtiter plates can be designed with a different number of reaction vessels. The microtiter plate with 6-4096 reaction vessels is common, wherein microtiter plates with 96, 384 or 1536 reaction vessels are the most common versions. In microtiter plates with 384 or 1536 reaction vessels, the individual reaction vessels are so thin that a liquid normally adheres in them due to capillary forces alone, so that even when such a microtiter plate is arranged with its openings facing downwards, the liquid does not flow out. This does not apply to microtiter plates with fewer reaction vessels, each of which is larger. Such a reaction vessel unit 8 can be inserted alone into a reception area 7 of the rotor 3 or on a carrier unit. Preferably, a carrier unit is used which has a coupling element that can be coupled to a loading and unloading device 9. Such a loading and unloading device 9 is shown, for example, in WO 2017/125598 A1, to which reference is made in full.

This loading and unloading device 9 has a rigid sliding rod 10, which can be detachably coupled at its free end by means of a coupling element 11 to the reaction vessel unit 8 or a carrier unit on which the reaction vessel unit 8 is located. The loading and discharge device 9 has a linear drive (not shown), with which the displacement rod 10 can be moved in its longitudinal direction in such a way that the reaction vessel unit 8 can be moved from a loading position to a discharge position 13, in which the reaction vessel unit 8 is located in the rotor 3. The loading and unloading device 9 can also be used to move the reaction vessel unit 8 from the discharge position 13 back to the loading position 12.

The housing 4 delimits a rotor chamber 14. In the present embodiment example, the area of the housing 4 delimiting the rotor chamber 14 is formed from a lower shell 15, an upper shell 16, a front end wall 17 and a back end wall 18. The back end wall is adjoined by further parts of the housing, which are not shown in the attached figures.

The front end wall 17 and the back end wall 18 each contain a ball bearing 19, in which a continuous shaft 20 of the rotor 3 is rotatably mounted. The centre line of the shaft 20 forms the rotation axis 6, which runs parallel to a base 22 of the centrifuge 1 or dispensing device. In the present embodiment example, the base 22 is formed by the underside of the lower shell 15 (FIG. 4).

The rear end of the shaft 20 is coupled to the drive unit 5. The other part of the housing, which adjoins the back end wall 18, contains the drive unit 5, the loading and unloading device 9 and a central control device (not shown), which is used to control all components of the centrifuge 1 or the dispensing device.

A balcony 23 is attached to the outside of the front end wall 17, which serves to hold a reaction vessel unit 8. At the level of the balcony 23, a loading and unloading opening 24 is formed in the front end wall 17, through which a reaction vessel unit 8 can be inserted into the rotor chamber 14 and pushed out again. The loading and unloading opening 24 is provided with a hinged door 25 so that the rotor chamber can be closed. Instead of a hinged door 25, a vertically or horizontally displaceable door can also be provided.

The loading and unloading device 9 can move the sliding rod 10 with its free end horizontally through the rotor chamber 14 via a through opening 26 on the back end wall 18. The displacement rod 10 can be coupled to the coupling element 11 on a reaction vessel unit 8 or on a carrier unit. Preferably, a carrier unit is provided which has a corresponding counter-coupling element. As a result, any reaction vessel units 8 can be moved automatically from the balcony 23 through the loading and unloading opening 24 in the rotor chamber 14, wherein the rotor 3 is arranged with a reception area 7 adjacent to the loading and unloading opening 24, so that the carrier unit or the reaction vessel unit 8 is displaced into the reception area 7 of the rotor 3. The coupling between the displacement rod 10 and the carrier unit or the reaction vessel unit 8 can be released, so that the carrier unit or the reaction vessel unit is freely movable in the rotor 3 and the rotor can be rotated accordingly with this unit.

The coupling element 11 can, for example, be a magnetic coupling element or be designed as a mechanical hook element.

By means of the sliding rod 10 of the loading and unloading device 9, the carrier unit or the reaction vessel unit 8 can be pushed out of the reception area 7 of the rotor 3 through the loading and unloading opening 24 back onto the balcony 23. The reaction vessel unit 8 can be removed from the balcony 23, for example by means of a robot.

If the reaction vessel unit 8 is located on the balcony 23, it is arranged in the loading position 12, in which the centrifuge 1 is equipped with a reaction vessel unit 8 and can thus be loaded. If the reaction vessel unit 8 is located in the reception area 7 of the rotor 3, the reaction vessel unit 8 is arranged in the discharge position 13, in which the reaction vessels of the reaction vessel unit 8 can be discharged by rotating the rotor 3 about the rotation axis 6.

The lower shell 15 has a channel 27 which runs approximately parallel to the rotation axis 6. The channel 27 extends from the back end wall 18 to the area of the front end wall 17, wherein it is inclined or sloped towards the front (FIG. 4). An outlet opening 28 is formed at the front of the lower shell 15, at which the channel 27 opens. A connection fitting 29 is arranged at the outlet opening 28, to which a hose 30 can be connected. The hose 30 generally opens into a receiving container (not shown), in which the liquids are received, which are ejected from the reaction vessels of the reaction vessel unit 8 in the centrifuge 1. The container preferably has a ventilation opening or the hose passes through the container with some play, so that liquid leaking from the centrifuge through the hose 30 does not generate any back pressure in the container.

Housing 4 essentially corresponds to that of WO 2018/234420 A1, which is why reference is made in full to this document.

A dispensing module 31 is arranged on the front end wall 17 in the area above the balcony 23. The dispensing module 31 has five dispensing heads 32, each with a row of dispensing nozzles 33. The dispensing heads 32 are magnetically coupled to the dispensing module 31 and to each other. Furthermore, positive locking elements are provided so that the position of the dispensing heads 32 is precisely aligned with respect to the dispensing module 31 and with each other. The positive locking elements can, for example, be pins and corresponding, precisely fitting recesses. However, the positive locking elements can also have other shapes, such as conical, in particular circular conical projections with corresponding recesses. Such conical projections and corresponding recesses are self-centring.

The dispensing heads 32 are aligned with their dispensing nozzles 33 facing downwards, so that liquid reagents can be introduced from the dispensing nozzles 33 into reaction vessels of the reaction vessel unit 8, which are aligned with respect to the dispensing nozzles 33 or the dispensing heads 32 by means of the loading and unloading device 9. The loading and unloading device 9 thus serves as a positioning device for positioning the reaction vessel unit 8 with respect to the dispensing nozzles 33 or the dispensing heads 32.

The dispensing heads 32/1 to 32/5 are each coupled to a liquid line 34/1 to 34/5 in order to supply a liquid reagent to the dispensing heads 32, which is dispensed via the dispensing nozzles 33 (FIG. 1).

The dispensing heads 32/2 to 32/5 are each connected to a pump module 35 (FIG. 2), which can supply liquid reagents from a common reagent stock 36 and from a respective individual reagent stock 37 to the corresponding dispensing heads 32/2 to 32/5.

The pump module 35 has a pump 21.

In the present embodiment example, the pump 21 is designed as a diaphragm pump. Such diaphragm pumps can have a very compact design. However, the pump can also be designed as a peristaltic pump. Peristaltic pumps are generally larger than diaphragm pumps. However, peristaltic pumps have the advantage that they can be used to pump liquids in both directions in the lines connected to them. A peristaltic pump can therefore be used not only for dispensing reagents using the dispensing heads, but also for aspirating reagents.

The pump modules 35 have a first inlet 39 and a second inlet 40 and an outlet 41. The first inlet is connected by means of a filter 42 to a 3/2-way valve 38, which is also referred to as a pump valve. The pump valve 38 is also connected to the second inlet 40 and the pump 21. The pump valve can be used to connect either the first inlet 39 or the second inlet 40 to the outlet 41.

A shut off valve 43 is provided between the pump 21 and the outlet 41.

The individual reagent stocks 37 are each connected to the first inlets 39 of the pump modules 35. Each individual reagent stock 37 has a single reagent storage container 44. The lines between these reagent storage containers 44 and the first inlets 39 of the pump modules 35 merely have connecting couplings for detachably connecting the reagent storage containers 44, but have no further elements, such as valves, branches or the like. These lines can be kept very short in order to minimise the volume limited by them. When the reagent storage containers 44 of the individual reagent stock 37 are replaced, these lines 45 must be rinsed, which means that the larger the volume of these lines 45, the greater the waste.

The second inlets 40 of the pump modules 35 are each connected to an outlet of a distributor arrangement 46.

The dispensing head 32/1 is also connected to an outlet of the distributor arrangement 46 via a liquid line in which no pump module 35, but only a pump 21 and a shut off valve 43 are arranged in succession in the direction of flow to the dispensing head 32/1. The distributor arrangement has five distributor valves 47. The distributor valves 47 are 2/2-way valves, which can also be referred to as switching valves. The distributor valves 47 are arranged in parallel to one another and the outlet of each distributor valve 47 forms an outlet 48 of the distributor arrangement 46. The inlets of the distributor valves 47 are connected to one another and led to a common inlet 49 of the distributor arrangement 46.

Thus, each outlet 48 of the distributor arrangement 46 is connected to a dispensing head 32. With the distributor arrangement 46, a liquid reagent, which is supplied at the inlet 41 of the distributor arrangement 47, can be selectively and individually supplied to one or more of the dispensing heads 32 by releasing the corresponding distributor valves 47. The distributor arrangement 46 thus serves to distribute a specific liquid reagent to one or more of the dispensing heads 32.

The input 49 of the distributor arrangement 46 is connected to an outlet 51 of a valve arrangement 50. A filter 52 is connected between the valve arrangement 50 and the distributor arrangement 46.

The valve arrangement has five valves 53. These valves 53 are 2/2-way valves. They are arranged parallel to one another, wherein all outlets of the valves 53 are connected to one another and form the outlet 51 of the valve arrangement 50. The inlets of the valves 53 each form a separate inlet 54 of the valve arrangement 50. These inlets 54 are each connected to a reagent storage container 55 via a liquid line. The reagent storage containers 55 are connected to the individual lines by a detachable coupling (not shown), so that the reagent storage containers can be exchanged.

The common reagent stock 36 thus comprises the reagent storage containers 55, the valve arrangement 50 and the distributor arrangement 46. The reagents, which are located in the different reagent storage containers 55, can be supplied individually to the respective dispensing heads 32 by means of the valve arrangement 50 and distributor arrangement 46.

In the present embodiment example, the common reagent stock 36 comprises five reagent storage containers 55. The number of reagent storage containers may vary. If more reagent storage containers 55 are provided, then correspondingly more valves 53 must be provided on the valve arrangement.

The distributor arrangement 46 has a separate distributor valve 47 for each dispensing head. If the number of dispensing heads 32 differs from five and is in particular greater, then a correspondingly different number of distributor valves 47 must be provided.

The dispensing device shown in FIG. 1 can be used to supply a specific reagent from the individual reagent stock 37 to each of the dispensing heads 32/2 to 32/5. These individual reagents can be very expensive reagents, such as reagents with individually produced biological substances, such as antibodies. These reagents can be automatically added to the reaction vessels in the reaction vessel unit 8 via the dispensing heads 32 and the corresponding dispensing nozzles 33. The reaction vessels are automatically arranged precisely under the dispensing nozzles 33 by means of the loading and unloading device 9. For this purpose, the loading and unloading device 9 preferably has a displacement sensor which detects the displacement movement of the displacement element, the displacement rod 10, and thus detects the position of the reaction vessel unit 8. This position can also be used to infer the position of the individual reaction vessels of the reaction vessel unit 8.

To avoid the risk of contamination of the dispensing nozzles 33, these can be rinsed regularly with a cleaning solution. Such a cleaning solution may be kept in one of the reagent storage containers 55 of the common reagent stock 36. Such a cleaning solution compares favourably with the special reagents which are kept in the individual reagent storage containers 44. Even though comparatively large amounts of reagent must be flushed when changing the reagents in the common reagent stock 36 in order to safely exchange the reagent in the lines from the reagent storage containers 55 via the valve assembly 50, via the manifold assembly 46, the pump modules 44 and the dispensing heads 32, the economic losses are low. The common reagent stock 36 allows several different reagents to be kept in larger quantities, which can be supplied to the individual dispensing heads as required.

The pump modules 35 (FIGS. 1, 2) thus allow the supply of individual reagents from the individual reagent stock 37 with very little waste and the supply of other reagents from the common reagent stock 36, wherein different reagents can be selected flexibly. This allows the dispensing nozzles to be cleaned regularly with one or different cleaning solutions, so that continuous operation is possible without the need for manual intervention. Furthermore, the dispensing heads can be used to supply further reagents from the common reagent stock 36, such as buffer solutions or the like.

After dispensing, the reaction vessels can be centrifuged with the centrifuge. In the embodiment example shown in FIG. 4, the reaction vessel unit is arranged in the rotor 3 with the openings of the reaction vessels facing outwards, so that the contents of the reaction vessels are spun out during centrifugation. To clean the reaction vessels, cleaning solutions can be added to them before centrifuging, which entrain the contaminants contained in the reaction vessels.

However, this centrifuge can also be used to purify magnetic beats by centrifuging and adding a washing solution with the aid of so-called magnetic carriers, wherein the magnetic beats are retained in reaction vessels by the magnetic carrier during centrifugation.

A washing solution is used to clean the reaction vessels and a cleaning solution is used to clean the dispensing nozzles. The washing solution and the cleaning solution may differ. However, it is also possible that the washing solution for washing the reaction vessels can also be used as a cleaning solution for cleaning the nozzles.

However, the centrifuge according to FIG. 4 can also be modified in such a way that the reaction vessel units 8 can be arranged with the openings of the reaction vessels pointing in the direction of the rotation axis 6. For this purpose, for example, the balcony 23 and the loading and unloading device 9 must be arranged below the rotation axis 6.

In such an embodiment, the reagents can be added to the individual reaction vessels of the reaction vessel unit 8 by means of the dispensing device according to FIG. 1 and then centrifuged by means of the centrifuge.

The embodiment example explained above is a centrifuge. Within the scope of the invention, it is also possible to form the dispensing device without a centrifuge. It is merely expedient to provide a positioning device in order to position the reaction vessel unit 8 relative to the dispensing heads 32 and/or the dispensing nozzles 33. Either the reaction vessel unit 8 and/or the dispensing heads 32 can be moved. A linear drive can be provided for this purpose, as is used in the loading and unloading device 9 described above. However, the reaction vessel unit 8 can also be arranged on a conveyor device, such as a conveyor belt, in order to achieve the relative movement between the reaction vessel unit 8 and the dispensing heads 32 or the dispensing nozzles 33.

The dispensing heads 32 of the embodiment example explained above each have a row of dispensing nozzles 33. In the present embodiment example, the individual dispensing heads have the same number of dispensing nozzles. However, it is also possible that the individual dispensing heads have a different number of dispensing nozzles. For example, microtiter plates are known which have a different number of reaction vessels in each successive row. For example, there are microtiter plates that have 16 reaction vessels in one row and 15 reaction vessels in the neighbouring row, wherein this arrangement with 15 and 16 reaction vessels is repeated again and again. For such special microtiter plates, it may be expedient to provide corresponding dispensing heads, wherein at least one dispensing head 15 has dispensing nozzles 33 and another dispensing head 16 has dispensing nozzles 33. The position of the individual dispensing nozzles 33 is arranged on the dispensing heads 32 such that they are aligned with the corresponding positions of the reaction vessels in the reaction vessel unit 8.

It is therefore expedient that the dispensing heads 32 are interchangeably fixed to the dispensing module 31 in order to adapt the pipetting device to different types of reaction vessel units 8.

FIGS. 5a and 5b show two different dispensing heads, each with 8 or 16 dispensing nozzles 33. These dispensing heads 32 each have a connection piece 56 on the side for connecting a liquid line and projections and/or recesses 57 on the contact surfaces to the dispensing module 31 or to further dispensing heads 32 in order to be able to establish a positive connection to the dispensing module 31 or to further dispensing heads 32. The connecting pieces 56 are inserted into or screwed into corresponding holes in the dispensing heads 32 with a press fit. These bores open into an inner chamber 59 (FIG. 8), from which the dispensing nozzles 33 branch off. A through-hole is formed at each end of the dispensing heads 32, in which either one of the connection pieces 56 or a corresponding sealing plug 58 is arranged.

Another aspect relates to a cleaning adapter 60 for a dispensing head 32 with at least one and preferably several dispensing nozzles 33. The cleaning adapter 60 has a jacket-shaped adapter body 61 with a bottom wall 62, two longitudinal side walls 63 and two end walls 64. The two longitudinal side walls 63 and the two end walls 64 delimit an upward-facing opening 65 (FIG. 6a). This opening 65 is adapted to the contour of the dispensing head 32, so that the cleaning adapter 60 can be attached to the dispensing head 32 from below and the opening 65 is flush with the dispensing head 32. The contact area between the dispensing head 32 and the cleaning adapter 60 is then sealed essentially fluid-tight.

Continuous cleaning openings 66 are formed in the bottom wall 62. Such a cleaning opening 66 is provided for each dispensing nozzles 33 and is arranged on the bottom wall 62 in such a way that one of the dispensing nozzles 33 extends through one of the cleaning openings 66 in each case.

The dispensing nozzles 33 are arranged with little clearance in a cleaning opening 66, so that an annular cleaning channel 67 is formed between the cleaning nozzles 33 and the cleaning openings 66.

The dispensing nozzles 33 protrude slightly on the underside of the bottom wall 62 (FIG. 8). In the present embodiment example, they protrude about 1 to 2 mm downwards on the cleaning adapter 60. The outer diameter of the dispensing nozzles 33 is 1 mm and the diameter of the cleaning opening 66 is 1.5 to 3 mm. A first and second connection opening 68, 69 is formed on each of the two end walls 64. Connecting pieces 70 are arranged on the outside of the end wall 64, to each of which a fluid line can be connected in such a way that it communicates with the interior of the cleaning adapter 60.

At the corner area between the two end walls 64 and one of the two longitudinal side walls 63, an upwardly projecting web 71 is formed in each case, which has a through opening in order to fasten the cleaning adapter 60 to a dispensing device by means of a screw bolt which extends through the through opening, to a dispensing device in such a way that the lower region of the dispensing head 32, on which the dispensing nozzles 33 are arranged, is enclosed by the cleaning adapter 60 and only the dispensing nozzles 33 protrude a little downwards through the cleaning openings 66 on the cleaning adapter 60. These webs 71 thus form fixing elements for fastening the cleaning adapter 60 to the dispensing device.

The cleaning adapter 60 thus arranged on the dispensing head 32 delimits with its interior a cleaning chamber 72 (FIG. 8), which surrounds a section of the dispensing nozzles 33 and is connected in communication with the first and second connection openings 68, 69 and the cleaning openings 66.

The fluid lines are usually flexible hoses, each of which is connected to a pump for supplying or removing a cleaning fluid.

The first connection opening 68 is connected to a fluid line for supplying a cleaning solution, which can be ethanol or an aqueous solution containing surfactants, for example. The corresponding pump is connected to a reagent storage container in which the cleaning solution is located.

The second connection opening 69 is connected to a fluid line for extracting air from the cleaning chamber 72. The suction of the air generates a corresponding air flow through the cleaning channels 67, which entrains drops of liquid hanging from the free ends or tips 73 of the dispensing nozzles 33, sucks them through the cleaning channel 67 and removes them from the cleaning chamber 72. The liquid contained therein is fed to a waste container.

If, on the other hand, fluid, in particular the liquid cleaning solution, is supplied to the cleaning chamber 72, it flows along the dispensing nozzles 33 through the cleaning channels 67 in order to clean the outer surface of the dispensing nozzles 33.

The cleaning chamber 72 can also be rinsed, for example by supplying cleaning solution to the cleaning chamber 72 via the first connection opening 68 and simultaneously removing it via the second connection opening 69.

With the cleaning adapter 60, the dispensing nozzles 33 can be cleaned regularly during operation without the need for manual intervention by an operator.

In the embodiment example explained above, the cleaning adapter 60 is a separate component with respect to the dispensing head 32. Within the scope of the invention, it is also possible for the cleaning adapter 60 to be an integral component of the dispensing head 32. This is particularly expedient if several dispensing heads 32 are arranged on a dispensing device, of which at least two or more and preferably all are to be provided with a cleaning adapter 60. An integral design of the cleaning adapter 60 and the dispensing heads 32 can be somewhat more compact than if the cleaning adapters 60 are provided as separate components.

However, the separate cleaning adapters 60 have the advantage that they can be retrofitted to existing dispensing heads 32.

List of reference symbols

1 Centrifuge
2 Dispensing device
3 Rotor
4 Housing
5 Drive unit
6 Rotation axis
7 Reception area
8 Reaction vessel unit
9 Loading and unloading device or positioning device
10 Sliding rod
11 Coupling element
12 Loading position
13 Discharge position
14 Rotor chamber
15 Lower shell
16 Upper shell
17 Front end wall
18 Back end wall
19 Ball bearings
20 Shaft
21 Pump
22 Base
23 Balcony
24 Loading and unloading opening
25 Door
26 Through opening
27 Channel
28 Outlet opening
29 Connection fitting
30 Hose
31 Dispensing module
32 Dispensing head
33 Dispensing nozzle
34 Liquid line
35 Pump module
36 Common reagent stock
37 Individual reagent stock
38 Pump valve
39 first inlet
40 Second inlet
41 Outlet
42 Filters
43 Shut off valve
44 Reagent storage container
45 Line
46 Distributor arrangement
47 Distributor valve
48 Outlet
49 Input
50 Valve arrangement
51 Outlet
52 Filters
53 Valve
54 Input
55 Reagent storage container
56 Connection piece
57 Projection/recess
58 Sealing plugs
59 Inner chamber
60 Cleaning adapter
61 Adapter body
62 Bottom wall
63 Longitudinal side wall
64 Front wall
65 Opening
66 Cleaning opening
67 Cleaning channel
68 First connection opening
69 Second connection opening
70 Connection piece
71 Web
72 Cleaning chamber

1. A dispensing device comprising
a linear drive for relatively moving a reaction vessel unit along a dispensing unit with at least two dispensing heads, each of which has at least one dispensing nozzle, so that a reaction vessel unit can be arranged under the dispensing nozzles of the dispensing unit in order to fill at least one reaction vessel of the reaction vessel unit,
pumps, which are each connected to one of the dispensing heads by a liquid line in order to convey a liquid reagent to the respective dispensing head,
wherein
a pump valve with a first and a second inlet and an outlet is arranged upstream of each of the two pumps, wherein the outlet can be connected to the respective pump, the first inlet to a common reagent stock and the second inlet in each case to an individual reagent stock.

2. The dispensing device according to claim 1, wherein a distributor arrangement with one inlet and several outlets is arranged between the common reagent stock and the pump valves, wherein each second inlet of the respective pump valve is connected to an outlet of the distributor arrangement.

3. The dispensing device according to claim 1, wherein the common reagent stock has a valve arrangement with a plurality of inlets and one outlet, wherein the outlet of this valve arrangement is connected to one or more of the first inlets of the pump valves and a reagent storage container can be coupled to each of the inlets of the valve arrangement.

4. The dispensing device according to claim 1, wherein the second inlets of the pump valves can each be coupled directly to a reagent storage container.

5. The dispensing device according to claim 1, wherein a shut off valve is arranged between the pumps and the respective dispensing head.

6. The dispensing device according to claim 1, wherein the liquid lines between the pumps and the respective dispensing heads have a smaller cross-section than liquid lines leading from the pumps to the reagent storage containers.

7. The dispensing device according to claim 1, wherein the dispensing heads each have a plurality of nozzles.

8. The dispensing device according to claim 1, wherein the dispensing heads can be detachably coupled to one another and/or that the dispensing heads are interchangeably arranged.

9. The dispensing device according to claim 1, wherein the dispensing heads each have a plurality of nozzles arranged in series, wherein each dispensing head has one or more rows of nozzles and the rows of nozzles each comprise the same number of nozzles or a different number of nozzles.

10. The dispensing device according to claim 1, wherein the dispensing heads can be coupled to one another in a form-fit manner.

11. The dispensing device according to claim 1, wherein a temperature control device is provided for controlling the temperature of a reagent to be supplied to the dispensing head.

12. The dispensing device according to claim 11, wherein the temperature control device is designed to control the temperature of a section of the liquid line and/or to control the temperature of at least one of the pumps.

13. The dispensing device according to claim 1, wherein a liquid line leading from one of the individual reagent stocks to the respective dispensing head is no longer than 40 cm, in particular no longer than 30 cm and preferably no longer than 20 cm.

14. The dispensing device according to claim 1, wherein a collecting basin for collecting liquid reagents dispensed with the dispensing nozzles is arranged in the region below the dispensing heads.

15. A centrifuge with a rotor and a rotor chamber in which the rotor is arranged and rotatably mounted, wherein the rotor has a reception area for receiving
the reaction vessel unit, and
the rotor chamber is bounded by a housing,
wherein the centrifuge has a dispensing device according to claim 1.

16. The method for cleaning dispensing nozzles, of a dispensing device according to claim 1 wherein the dispensing nozzles are arranged on at least two different dispensing heads and reagents are dosed to each dispensing head with a respective pump and using a pump valve arranged upstream of the pump and having a first inlet and a second inlet, and an outlet, wherein the outlet is connected to the pump, the first inlet is connected to a common stock of cleaning solution and the second inlet is each connected to an individual reagent stock containing the respective reagent, so that the wash solution for rinsing the dispensing nozzles is supplied to the respective dispensing heads as required by means of the pump valves.

17. A cleaning adapter for a dispensing head having one or more dispensing nozzles for dispensing a liquid reagent via at least one nozzle, wherein
the cleaning adapter has a trough-shaped adapter body with a bottom wall, two longitudinal side walls and two end walls, which define an upwardly pointing opening,
wherein the upwardly pointing opening is adapted to the contour of the dispensing head in such a way that the cleaning adapter can be attached to the dispensing head at the region where the dispensing nozzles protrude in such a way that the cleaning adapter lies essentially fluid-tight against the dispensing head,
a through cleaning opening is formed in the bottom wall for each dispensing nozzle of the dispensing head, so that when the cleaning adapter is attached to the dispensing head, one of the dispensing nozzles extends through one of the through openings in each case, the dispensing nozzles being arranged in the cleaning openings with some play in each case, and
the cleaning adapter has at least one connection opening with a connection element for connecting a line for supplying or discharging a cleaning fluid.

18. The cleaning adapter according to claim 17, wherein the cleaning adapter has at least two connection openings, which are preferably arranged diametrically opposite each other on the end walls.

19. The cleaning adapter according to claim 17, wherein an elastic sealing element is provided in the region of the upwardly pointing opening for sealing the cleaning adapter with respect to the dispensing head.

20. The cleaning adapter according to claim 17, wherein it comprises fixing elements for fixing the cleaning adapter to the dispensing head and/or to a dispensing device comprising the dispensing head.

21. The dispensing head with one or more dispensing nozzles for dispensing a liquid reagent via the at least one dispensing nozzle, wherein it has a cleaning adapter according to claim 17.

22. The dispensing head according to claim 21, wherein the cleaning adapter is integrally formed on the dispensing head.

23. The dispensing device comprising
a dispensing head having at least one dispensing nozzle for dispensing a liquid reagent via the at least one dispensing nozzle, wherein
the dispensing device comprises a cleaning adapter according to claim 17 and is provided with a pump which is connected to the cleaning connection by a fluid line for supplying or removing a cleaning fluid to or from the cleaning adapter.

24. The method for cleaning one or more dispensing nozzles of a dispensing device according to claim 23,
wherein a cleaning fluid is either
supplied exclusively to the cleaning adapter, so that the dispensing nozzle(s) is/are rinsed with the cleaning fluid, or
is drawn off exclusively from the cleaning adapter so that droplets on the dispensing nozzles are drawn into the cleaning adapter, or
is simultaneously fed to the cleaning adapter via one connection opening and drawn off via another connection opening so that the cleaning adapter is rinsed.

25. The method according to claim 24, wherein the cleaning fluid is one or a mixture of the following fluids:
air
alcohols
Aqueous solution, especially with surfactants
acid, e.g. citric acid, acetic acid
base, such as caustic soda (NaOH), caustic potash (KOH), sodium hypochlorite.
